(19) United States
(12) Patent Application Publication
(10) Pub. No.: US 2013/0014511 A1
(43) Pub. Date: Jan. 17, 2013

(54) HIGHLY INTEGRATED INSIDE-OUT RAMJET

(71) Applicant: Michael Gurin, Glenview, IL (US)

(72) Inventor: Michael Gurin, Glenview, IL (US)

(21) Appl. No.: 13/342,988

(22) Filed: Jan. 4, 2012

Related U.S. Application Data
(60) Provisional application No. 61/429,713, filed on Jan. 4, 2011.

(51) Int. Cl. F02K 7/10

(52) U.S. Cl. 60/767

(57) ABSTRACT

The present invention generally relates to power generation and compression methods requiring high efficiency and low capital cost. In one embodiment, the present invention relates to an inside-out ramjet having both circumferential components and radial components on a single shaft to maximize exergy efficiency and minimize system size.

### FIELD OF THE INVENTION

The present invention generally relates to compression for standalone air/gas/refrigerant applications including power generation having a preferred inside out configuration to maximize compressive/centrifugal forces on rotating components. The features are essentially identical for expansion in standalone air/gas/refrigerant applications including power generation. In the preferred embodiment, the present invention utilizes a first inside out ramjet preferably with a second inside out ramjet as either compressor or expander.

### BACKGROUND OF THE INVENTION

Due to a variety of factors including, but not limited to, global warming issues, fossil fuel availability and environmental impacts, crude oil price and availability issues, alternative energy consuming compressors with or without power generation methods must be developed to reduce carbon dioxide emissions.

Many of the most significant consumers of electricity (or mechanical energy) require compression of a working fluid, which in itself is a compressible/expandable gas. Compression is also the first step of power generation for any Brayton cycle. Any improvement to energy efficiency of the compression process translates into enhanced energy efficiency of the entire power generation cycle. The last step of power generation is expansion through an expander.

The combined limitations of each individual component being a compressor or expander are further elaborated when seeking to maximize system energy efficiency.

### SUMMARY OF THE INVENTION

The present invention preferred embodiment relates to ultra-high temperature power production process having a high temperature exhaust that is subsequently utilized with a cascading cycle to maximize exergy efficiency. The preferred embodiment further includes a supercritical CO2 thermodynamic power generating cycle to incorporate at least two compression stages per shaft, and at least two expansion stages per shaft.

### BRIEF DESCRIPTION OF THE DRAWINGS

FIG. 1 is an axial view cross section of an inside-out ramjet with three radial view cross section scenarios in accordance with the present invention;

FIG. 2 is a radial view cross section of an inside-out ramjet in accordance with the present invention;

FIG. 3 is an axial view cross section of two inside-out ramjets on a common shaft in accordance with the present invention;

FIG. 4 is an axial view cross section of either a two stage inside-out ramjet compressor with inter-stage cooling, or an inside-out ramjet compressor with external heating and an inside-out ramjet expander on a common shaft in accordance with the present invention;

FIG. 5 is an axial view cross section of two inside-out ramjets on a common shaft showing the internal electrical/magnetic components in accordance with the present invention;

FIG. 6 is an axial view cross section of either a two stage inside-out ramjet compressor with inter-stage cooling, or an inside-out ramjet compressor with external heating and an inside-out ramjet expander on a common shaft showing the internal electrical/magnetic components in accordance with the present invention;

FIG. 7 is a radial view cross section of an inside-out ramjet with an outside-in ramjet on a common shaft in accordance with the present invention;

FIG. 8 is a radial view cross section of two inside-out ramjets on a common shaft in accordance with the present invention;

FIG. 9 is an axial view cross section of either a two stage inside-out ramjet compressor with inter-stage cooling, or an inside-out ramjet compressor with external heating and an inside-out ramjet expander on a common shaft showing the internal electrical/magnetic components and working fluid flows with entry and discharge on the same side but with separate volutes in accordance with the present invention;

FIG. 10 is an axial view cross section of either a two stage inside-out ramjet compressor with inter-stage cooling, or an inside-out ramjet compressor with external heating and an inside-out ramjet expander on a common shaft showing the internal electrical/magnetic components and working fluid flows with entry and discharge on the same side with adjacent volutes in accordance with the present invention;

FIG. 11 is an axial view cross section of either a two stage inside-out ramjet compressor with inter-stage cooling, or an inside-out ramjet compressor with external heating and an inside-out ramjet expander on a common shaft showing the internal electrical/magnetic components and working fluid flows with entry and discharge on the opposite sides in accordance with the present invention;

FIG. 12 is a radial view cross section of the spool with embedded electro-magnetic coil outward facing in accordance with the present invention.

FIG. 13 is a radial view cross section of the spool with embedded electro-magnetic coil axial facing in accordance with the present invention.

FIG. 14 is a radial view cross section of the spool with embedded electro-magnetic coil in a multi-layer configuration and outward facing in accordance with the present invention.

FIG. 15 is an axial view cross section having both ramjet and radial/centrifugal components on a common shaft in accordance with the present invention;

FIG. 16 is an axial view cross section having both ramjet and radial/centrifugal components on a common shaft with adjacent volutes in accordance with the present invention;

FIG. 17 is another axial view cross section having both ramjet and radial/centrifugal components on a common shaft with adjacent volutes in accordance with the present invention;

FIG. 18 is yet another axial view cross section having both ramjet and radial/centrifugal components on a common shaft with adjacent volutes in accordance with the present invention;

FIG. 19 is an axial view cross section having two stages depicting two scenarios of working fluid inlet and discharge with first stage at a larger radial distance from the centerline than the second stage;

FIG. 20 is an axial view cross section having two stages depicting two scenarios of working fluid inlet and discharge with second stage at a larger radial distance from the centerline than the first stage.

### DETAILED DESCRIPTION OF THE INVENTION

The term “in thermal continuity” or “thermal communication”, as used herein, includes the direct connection between the heat source and the heat sink whether or not a thermal interface material is used.

The term “fluid inlet” or “fluid inlet header”, as used herein, includes the portion of a heat exchanger where the fluid flows into the heat exchanger.

The term “fluid discharge”, as used herein, includes the portion of a heat exchanger where the fluid exits the heat exchanger.

The term “expandable fluid”, as used herein, includes the all fluids that have a decreasing density at increasing temperature at a specific pressure of at least a 0.1% decrease in density per degree C.

The term “working fluid” is a liquid medium utilized to convey thermal energy from one location to another. The terms heat transfer fluid, working fluid, and expandable fluid are used interchangeably.

The term “ramjet” is a rotary device that eliminates the need for a conventional bladed compressor (when a ramjet compressor) and turbine (when a ramjet expander) as used in traditional gas turbine engines.

The term “inside-out” is a device having a circumferential rotor with integrated and varying-area shaped channels in its radially inward surface, in that either compression, combustion and expansion occur. The “inside-out” design places all rotating parts under compressive centrifugal loading.

The term “outside-in” is a device having a circumferential rotor with integrated and varying-area shaped channels in its radially outward surface, in that either compression, combustion and expansion occur. The “outside-in” design places all rotating parts under tensile loading.

The term “radial/centrifugal” is a device having a radial rotor with integrated and varying-area shaped channels in its radially outward surface in that either compression or expansion occur. The “radial/centrifugal” design typically has one inlet or discharge port in an axial orientation and the other inlet or discharge port in a radial orientation.

The term “recuperator” is a method of recovering waste heat downstream of an expander and transferring the thermal energy upstream of either a compressor, turbocompressor or pump.

The term “external heater” is a method of heating (i.e., increasing enthalpy) of a working fluid utilizing a heat exchanger as opposed to in-situ combustion of the working fluid.

Every configuration and embodiment has a control system and method of control to operate in an energy efficient and optimal manner such that a power generation cycle obtains the highest exergy and enthalpy efficiency, and a compression cycle achieves both the desired discharge pressure at the lowest energy consumption.

In general, components that are depicted as shaded are components that move (in context of this invention, it is radial movement “around” the shaft) while components that are void of shading are stationary.

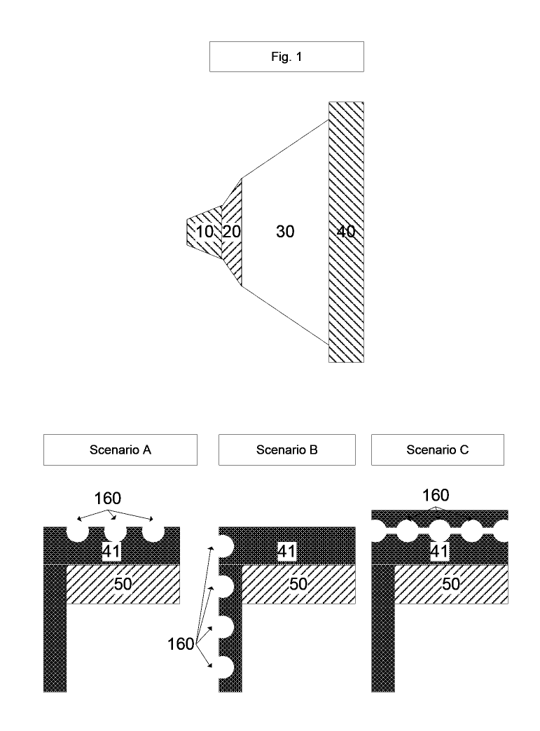

Turning to FIG. 1, FIG. 1 is an axial cross section depicting a single stage ramjet having a working fluid impeller 10, which is a radial impeller, a fuel slinger 20 (which is required only for a ramjet having internal combustion within the combustor), a spacer 30 (which can vary in size as a function of working fluid density, velocity, and rotation per minute “RPM”), and ramjet 40. The ramjet 40 as depicted can be solely the compression stage, or the expansion stage. The ramjet 40 as depicted can also be an integrated compression stage, combustor, and expansion stage. The compression stage as a ramjet compressor has a supersonic diffuser. The expansion stage as a ramjet expander has a supersonic nozzle. The compression ratio, which is the pressure ratio between the inlet pressure and the discharge pressure is between 1:1.2 to 1:20, with the preferred pressure ratio between 1:1.5 to 1:13, with the specifically preferred pressure ratio between 1:2.5 to 1:12, and the particularly preferred pressure ratio is between 1:2.5 to 1:4 for supercritical CO2 as a working fluid within a power generation thermodynamic cycle. FIG. 1 Scenario A has optional cooling channels 160 (also referred to as grooves) on the circumferential portion of the spool 41, with the spool containing the rotor 50 (which is typically a high temperature ceramic subjected to high compression loading) to reduce thermal energy first of the spool portion 41 of the ramjet 40 and by way of conduction secondly of the rotor 50 portion of the ramjet 40. The cooling channels 160 are particularly required for the integrated ramjet 40 having all three stages (compression, combustion, and expansion) due to the particularly high temperatures desired in order to maximize the thermodynamic efficiency in a Brayton cycle. The cooling channels 160 can also serve as a method of providing inter-stage cooling when the ramjet 40 is solely the compression stage. FIG. 1 Scenario B has the same functionality as FIG. 1 Scenario A, with the exception that the cooling channels 160 are on the radial portion of the spool 41. FIG. 1 Scenario C has the same functionality as FIG. 1 Scenario A, with the exception that the cooling channels 160 are embedded within the spool 41 such that a continuous flow path network exists from one side of the spool (in an axial direction) to the other in order to minimize windage losses.

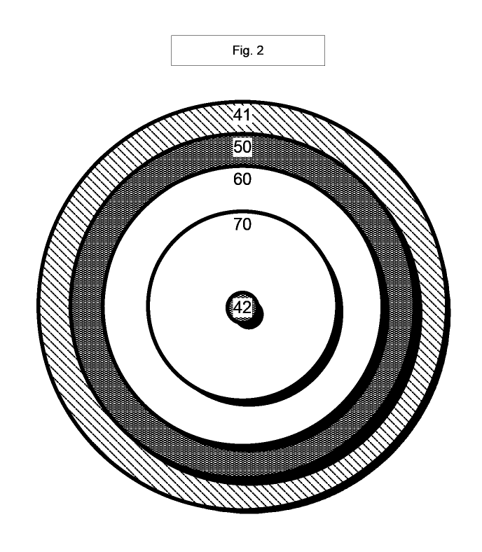

Turning to FIG. 2, FIG. 2 is a radial cross section view of one embodiment of the ramjet. The spool 41 contains the rotor 50 in order to transfer the tensile forces through the shaft 42. A space exists for the working fluid flow path between the rotor 50 and the stator 60. When the ramjet is an integrated compression, combustion, and expansion stage, very high temperature materials are required. These materials are typically ceramics, which are superior for compressive loading but poor for tensile loading. The spool 41 and stator rim 70 are typically made of metal or fiber reinforced composite, both respectively containing the rotor and stator subjected to high compressive loading.

Turning to FIG. 3, FIG. 3 is an axial cross section view of one embodiment of the ramjet. This embodiment has two separate ramjets, preferably of equivalent size and capacity, back to back to significantly reduce thrust loads (a particularly important benefit in view of the high rotational speeds of the ramjet, subjecting severe forces on all bearings including thrust bearings). FIG. 3 depicts each ramjet as a single stage ramjet having a working fluid impeller 10, which is a radial impeller, a fuel slinger 20 (which is required only for a ramjet having internal combustion within the combustor), a spacer 30 (which can vary in size as a function of working fluid density, velocity, and rotation per minute “RPM”), and ramjet 40. The ramjet 40 as depicted can be solely the compression stage, or the expansion stage. The ramjet 40 as depicted can also be an integrated compression stage, combustor, and expansion stage. The working fluid is discharged through the volute 80 in a radial manner as shown by piping 170. Another embodiment as depicted can have one of the two separate ramjets 40 (first) be solely the compression stage and the other of the two separate ramjets 40 (second) be solely the expansion stage such that external heating (not depicted) will increase the enthalpy between the compression and expansion stage. Yet another embodiment as depicted can have the first ramjet 40 be a compression stage for a first thermodynamic cycle, and the second ramjet 40 be a compression stage for a second thermodynamic cycle. Another embodiment as depicted can have the first ramjet 40 be a first compression stage for a first thermodynamic cycle, and the second ramjet 40 be a second compression stage for the first thermodynamic cycle.

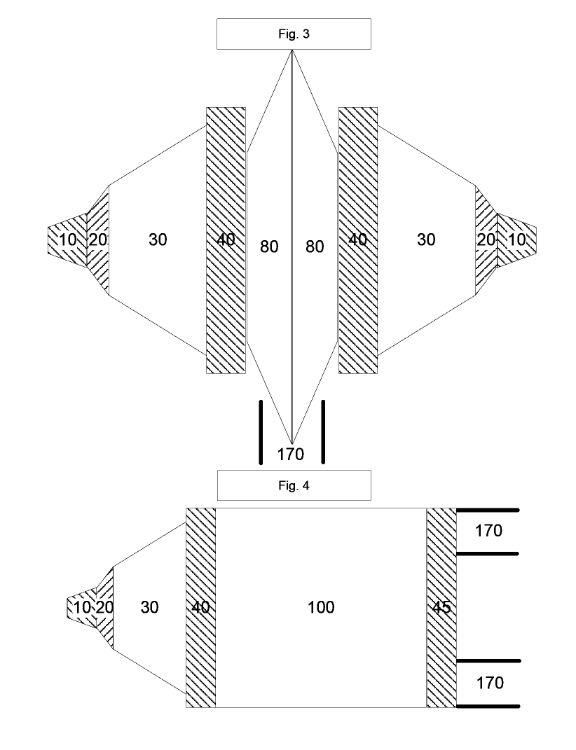

Turning to FIG. 4, FIG. 4 is an axial cross section view of one embodiment of the ramjet. This embodiment has two separate ramjets, preferably having at least 10 percent counteracting thrust loads. FIG. 4 depicts each ramjet as a single stage ramjet having a working fluid impeller 10, which is a radial impeller, a fuel slinger 20 (required only for a ramjet having internal combustion within a combustor, though not preferred), a spacer 30 (which can vary in size as a function of working fluid density, velocity, and rotation per minute “RPM”), and first ramjet 40 that is first compression stage. The second ramjet 45 is downstream of the heat exchanger 100, with the heat exchanger 100 operable as a recuperator, preheat heat exchanger, solar receiver, or combustion stage not within the circumferential rotor of the ramjet. The working fluid is discharged through the volute 170 in an axial manner as shown by piping 170. Another embodiment as depicted can have one of the two separate ramjets 40 (first) be a first integrated compression, combustion, and expansion stage and the other of the two separate ramjets 45 (second) be a second expansion stage such that external heating from the heat exchanger 100 (effectively reheat stage) will increase the enthalpy prior to the second expansion stage. Another embodiment as depicted can have the first ramjet 40 be a first compression stage for a first thermodynamic cycle, and the second ramjet 45 be a second compression stage for the first thermodynamic cycle with the heat exchanger downstream of the first ramjet 40 and upstream of the second ramjet 45 providing inter-stage cooling to improve energy efficiency as known in the art.

Turning to FIG. 5, FIG. 5 is an axial cross section with the additional depicting of electro-magnetic components as compared to FIG. 3. The impeller 10 and fuel slinger 20 are as depicted in FIG. 3. The shaft 42, which is common to all of the rotating components as shown, is also an electro-magnetic coil. The shaft 42 is rotationally linked to the impeller 10, the fuel slinger 20, and the ramjet 40. Though depicted as having all portions of the shaft 42 having the electro-magnetic coil, it is envisioned that the electro-magnetic coil portions can be solely within any one of the portion within either or both of the spacer(s) 30, within either or both of the volute(s) 80, and/or within the ramjet 40 portion. The magnetic (or electro-magnetic) stator 130 in one embodiment is within stationary portion of the ramjet stator. The magnetic stator (135 and/or 137) is within the spacer 30 of the ramjet. The magnetic stator 136 can also be within the volute 80. The electro-magnetic rotor 131 is attached and/or embedded within the spool of the ramjet, such that the magnetic stator 140 provides for a thrust bearing (and/or electrical generator). The discharge of the working fluid is through the volute 80 and into piping 170. Another embodiment as depicted is such that the electro-magnetic rotor 131 with the magnetic (or electro-magnetic) stator 140 is operable as an axial motor (when ramjet is only compression stage) or an axial generator (when ramjet is at least the expansion stage).

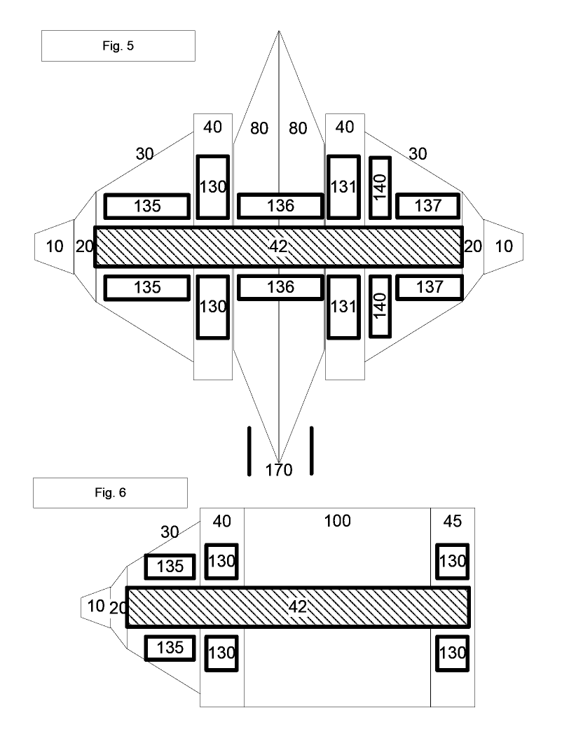

Turning to FIG. 6, FIG. 6 is an axial cross section depicting electro-magnetic components (as compared to FIG. 4). The impeller 10 and fuel slinger 20 are identical to FIG. 4. The shaft 42, which contains electro-magnetic coil, is rotationally linked to impeller 10 and slinger 20, as well as first ramjet 40 and second ramjet 45. Magnetic (or electro-magnetic) stator are contained (and isolated from at least high pressure side of working fluid within at least one of space 30, first ramjet 40, or second ramjet 45.

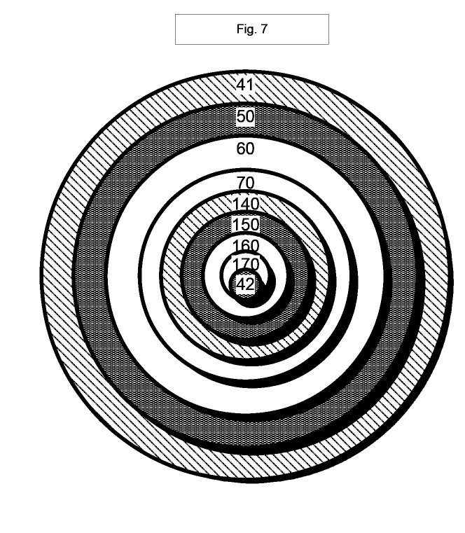

Turning to FIG. 7, FIG. 7 is a radial cross section depicting two ramjets rotationally linked within the same spool. The two ramjets in this embodiment are both inside-out ramjets, of which each of the ramjets can be at least one of compression, combustion, and/or expansion stage. The precise inter-relationship in terms of diameter of the first ramjet to the second ramjet varies as a function of the working fluid thermophysical properties and the overall thermodynamic cycle(s). The first ramjet is comprised of spool 41, rotor 50, stator 60, and stator rim 70. The second ramjet is comprised of spool 140, rotor 150, stator 160, and stator rim 170. Both ramjets rotate by rotationally linkage to shaft 42. It is understood in the art that the shaft 42 can be two concentric shafts rotating at different RPM, or even rotating at different rotational orientations (i.e., clockwise or counter-clockwise).

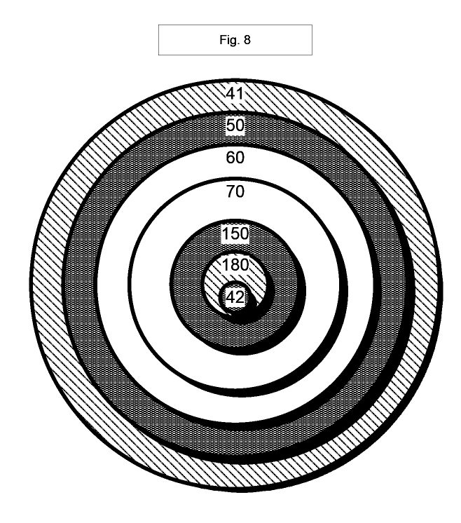

Turning to FIG. 8, FIG. 8 is a radial cross section depicting two ramjets rotationally linked with the same spool. The first ramjet (having greater diameter) in this embodiment is an inside-out ramjet while the second ramjet (having shorter diameter) is an outside-in ramjet, of which the first ramjet can be at least one of compression, combustion, and/or expansion stage; and the second ramjet can also be at least one of compression, combustion, and/or expansion stage though preferably the outside-in ramjet doesn't contain the combustion stage due to flame instabilities. The precise inter-relationship in terms of diameter of the first ramjet to the second ramjet again varies as a function of the working fluid thermophysical properties and the overall thermodynamic cycle(s). The first ramjet is comprised of spool 41, rotor 50, stator 60, and stator rim 70. The second ramjet is comprised of spool 180, and rotor 150, while utilizing a common stator 60, and a common stator rim 70 as the first ramjet. Both ramjets rotate by rotationally linkage to shaft 42. It is again understood in the art that the shaft 42 can be two concentric shafts rotating at different RPM, or even rotating at different rotational orientations (i.e., clockwise or counter-clockwise).

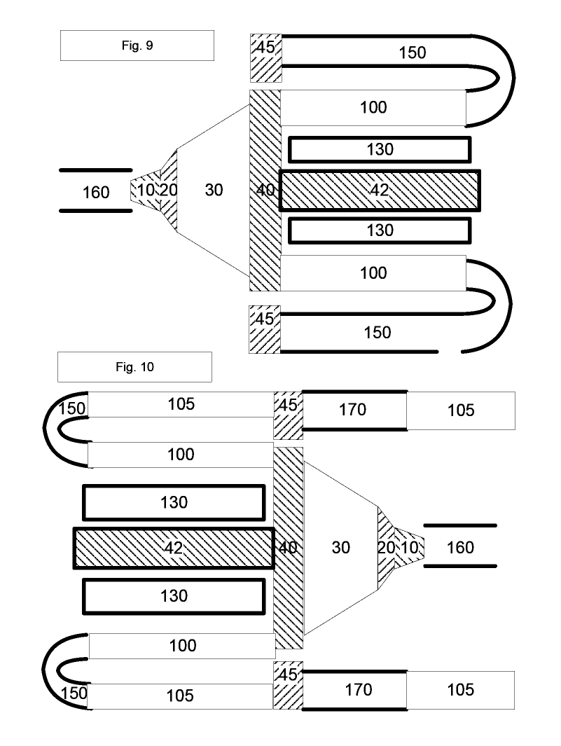

Turning to FIG. 9, FIG. 9 is an axial cross section depicting two ramjets rotationally linked with the same spool. The inlet volute 160, impeller 10, fuel slinger 20, spacer 30, and first ramjet 40 are identical as in FIG. 1. The fuel slinger 20 is optional, and can also serve as a liquid atomizer in cases where the working fluid has at least 2 percent saturated liquid. The ramjet 40 in one embodiment is solely a compression stage with a downstream inter-stage cooler 100. The working fluid then subsequently enters a volute 150 for the second ramjet 45. It is understood that the distance along the radial direction can be simply enough distance to maintain separate flows between the two ramjets 40 and 45, or a precise distance to optimize the energy efficiency and compression ratio by determining the optimal working fluid velocity (which is a function of RPM and radius). The spool in radial communication with both ramjets 40 and 45 is connected to the shaft 42. The preferred embodiment has embedded coils as depicted in FIGS. 12, 13, and 14. The electro-magnetic stator 130 surrounds the shaft 42 operable as the motor for this embodiment. In this embodiment the heat exchanger 100 is operable as an inter-stage cooler due to its placement relative to the shaft 42 and stator 130 provides a level of safety containment of the high speed rotating components. Another embodiment as depicted in this FIG. 9 is such that the first ramjet 40 has integrated compression, combustion, and expansion stages. In this embodiment, the heat exchanger 100 is operable as a reheat stage to enable additional energy to be extracted out of the second ramjet 45 operable as only an expansion stage. Also in this embodiment the combination of the shaft 42 and the electro-magnetic stator 130 is operable as a generator (and optionally as a motor during startup as known in the art).

Turning to FIG. 10, FIG. 10 is similar to FIG. 9 with the exception of the heat exchanger 100 is operable as an external heater, and the heat exchanger 105 is operable as a recuperator taking waste heat from downstream of the second ramjet 45 to downstream of the first ramjet 40. The first ramjet 40 is solely a compression stage, and the second ramjet 45 is solely an expander. The fuel slinger 20 as depicted here either optional or an extension of the impeller 10. The inlet volute 160 is nested in the discharge volute 170 as a method to reduce the physical size and weight.

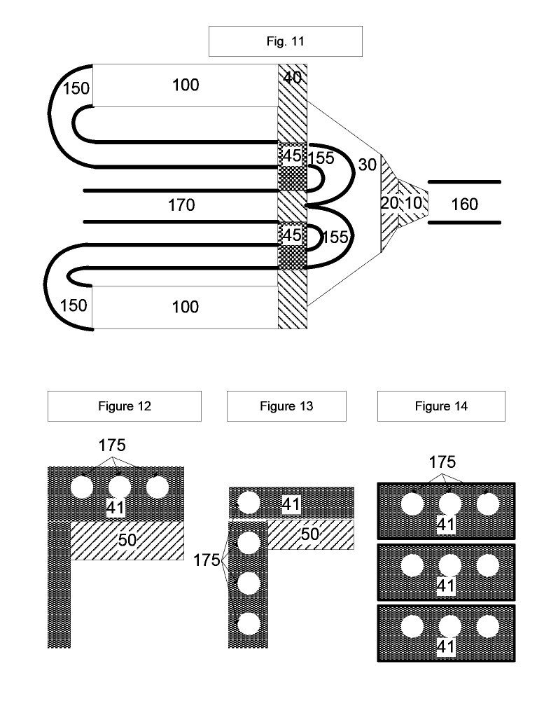

Turning to FIG. 11, FIG. 11 is also similar to FIGS. 9 and 10 with the principal exception of the inlet volute 160 and discharge volute 170 are on opposite ends of the ramjet system enabling the ramjet system to be in line with the working fluid piping. An additional volute 155 is utilized within the spacer 30 to further reduce the physical size and weight. Yet another additional difference is the relationship of the first ramjet 40 and the second ramjet 45 such that the second ramjet 45 is on the spool at a smaller radius then the first ramjet 40, thus impacting the working fluid velocity. As depicted here, the working fluid can discharge through the shaft thus the shaft is the discharge volute 170. It is understood that the working fluid can be discharged on the outward facing surface of a shaft.

Turning to FIG. 12, FIG. 12 depicts the embedded conductors 175 within the spool 41 of the ramjet that contains the rotor 50. In this embodiment the embedded conductors 175 are on the circumferential portion of the spool 41.

Turning to FIG. 13, FIG. 13 depicts the embedded conductors 175 within the spool 41 of the ramjet that contains the rotor 50. In this embodiment the embedded conductors 175 are on the radial portion of the spool 41.

Turning to FIG. 14, FIG. 14 depicts the embedded conductors 175 as multilayer coils, such as known in the art of the preferred double-helix coils.

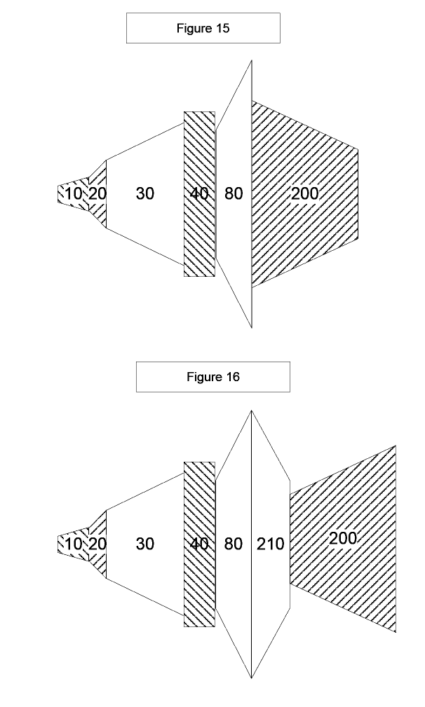

Turning to FIG. 15, FIG. 15 is an axial cross section depicting a multistage device containing one ramjet and one radial/centrifugal component. The impeller 10, fuel slinger 20 (optional), and spacer 30 are identical as in FIG. 1. The ramjet 40 can be solely a compression stage or an integrated compression, combustion, and expansion stage. The discharge volute 80 isolates the working fluid from the ramjet discharge and the radial/centrifugal component 200. The radial/centrifugal component 200 can be a second compression stage or a second expansion stage. It is understood that the dimensions of each stage relative to each other can be such that radial distance from the centerline (i.e., shaft) of the ramjet stage can be greater than radial/centrifugal stage, or radial distance from the centerline (i.e., shaft) of the ramjet stage can be less than radial/centrifugal stage. In any event, this embodiment has the discharge of the ramjet stage being adjacent to the inlet of the radial/centrifugal stage when the radial/centrifugal stage is a compressor; or adjacent to the discharge of the radial/centrifugal stage when an expander.

Turning to FIG. 16, FIG. 16 is substantially identical to FIG. 15 with the exception of the radial/centrifugal stage 200 has an adjacent volute 210 to the ramjet stage volute 80. This embodiment has the discharge of the ramjet stage being adjacent to the inlet of the radial/centrifugal stage when the radial/centrifugal stage is an expander; or adjacent to the discharge of the radial/centrifugal stage when a compressor.

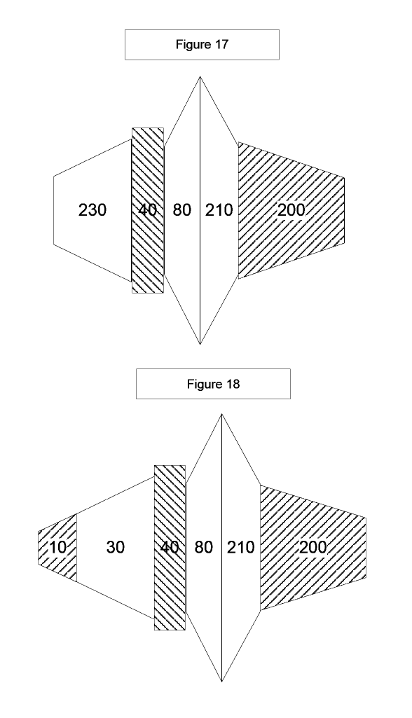

Turning to FIG. 17, FIG. 17 is an axial cross section of ramjet expander 40 and a radial/centrifugal expander 200. The working fluid of the ramjet expander 40 is guided by a stationary flow guide 230 to prepare the working fluid with the proper axial and radial flow vector prior to ramjet expander 40 entry. The discharge of the ramjet expander 40 is guided by its volute 80, which is adjacent to the radial/centrifugal expander 200 volute 210. This embodiment can be implemented when the ramjet expander 40 is a first expansion stage and the radial/centrifugal expander 200 is a second expansion stage. Alternatively, this embodiment can be implemented when the ramjet expander 40 is the expander for a first thermodynamic cycle and the radial/centrifugal expander 200 is the expander for a second thermodynamic cycle. In either event, this configuration enables both expanders to share one shaft.

Turning to FIG. 18, FIG. 18 is an axial cross section of ramjet compressor 40 and a radial/centrifugal compressor 200. The working fluid of the ramjet compressor 40 is guided by the impeller 10 and then spacer 30 to prepare the working fluid with the proper axial and radial flow vector prior to ramjet compressor 40 entry. The discharge of the ramjet compressor 40 is guided by its volute 80, which is adjacent to the radial/centrifugal compressor 200 volute 210. This embodiment can be implemented when the ramjet compressor 40 is a first compression stage and the radial/centrifugal compressor 200 is a second compression stage. Alternatively, this embodiment can be implemented when the ramjet compressor 40 is the compressor for a first thermodynamic cycle and the radial/centrifugal compressor 200 is the compressor for a second thermodynamic cycle. In either event, this configuration enables both compressors to share one shaft.

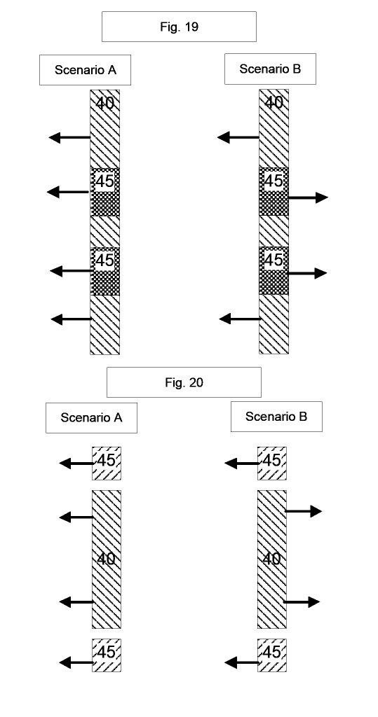

Turning to FIG. 19, FIG. 19 is an axial cross section having two separate ramjets depicting working fluid flows. Both scenarios have the first ramjet having a greater radial distance from the centerline as compared to the second ramjet. FIG. 19 Scenario A depicts the working fluid inlets and discharge ports being on the same side for both the first and second ramjets. FIG. 19 Scenario B depicts the working fluid inlets and discharge ports being on opposite sides for the first ramjet as compared to the second ramjet. Both the first and second ramjets can have at least one stage selected from compression, combustion, and expansion stages, and the first and second ramjets can have different configurations.

Turning to FIG. 20, FIG. 20 is an axial cross section having two separate ramjets depicting working fluid flows. Both scenarios have the second ramjet having a greater radial distance from the centerline as compared to the first ramjet. FIG. 20 Scenario A depicts the working fluid inlets and discharge ports being on the same side for both the first and second ramjets. FIG. 19 Scenario B depicts the working fluid inlets and discharge ports being on opposite sides for the first ramjet as compared to the second ramjet. Both the first and second ramjets can have at least one stage selected from compression, combustion, and expansion stages, and the first and second ramjets can have different configurations.

It is understood in virtually all of the figures that an exterior encasement is present, though not graphically depicted for visual clarity. It is also understood that both the size relationship of each device, including the radial distance from the shaft can substantially vary from the size shown in the figures. It is further understood that figures depicting a fuel slinger 20 and/or a spacer 30 can be additional embodiments without either or both.

The preferred embodiments are now set forth. As noted earlier, the ramjet can be the combination of compression, combustion, and expansion stages in one circumferential rotating device. Numerous compression applications require energy efficiency and separation of each of the stages to achieve optimal system efficiency that are not enabled by all three stages effectively in one integrated stage. The preferred embodiment for the rotary ramjet is a supersonic diffuser where the supersonic diffuser (i.e., compressor) is a first inside-out compressor. The inside-out compressor has the rotor subjected solely to compressive loads. The rotor is contained within a spool to provide containment and connection to the shaft in order to absorb the tensile forces.

The yet preferred embodiment, particularly when the compression ratio is greater than 15:1 (discharge:inlet pressure, or even greater than 8:1 depending on the working fluid density and compressibility) is for the spool to contain a second ramjet, again configured as a second compressor (i.e., only compression stage) having an outside-in configuration. The integration of the inside-out (having a radial distance from the shaft centerline greater than the outside-in compressor enables one stator ring to be the stator for both compression stages concurrently. The outward facing side of the compressor stator is for the first inside-out compressor and the inward facing side of the compressor stator is for the second outside-in compressor. The particularly preferred embodiment has an electrical (i.e., electro-magnetic coil) embedded into to the spool. The spool imparts a compressive force to counteract the Lorentz forces acting on the electrical coil. It is recognized within the art, that integrating a thermal barrier between the rotor and spool reduces heat transfer into the embedded electrical coil. The integration of the embedded electrical coil greatly reduces the surface area, which is a necessary condition to reduce windage losses. The ramjet compressor, in the preferred embodiment, places a magnetic stator within the stationary components (i.e., spacer, or even external of the ramjet compressor encasement) where the stationary components are manufactured of a magnetically transparent material. This serves a secondary function of also reducing windage losses by limiting aerodynamic interaction between the electrical coil and magnetic stator. When the ramjet is compressing a preferred working fluid to its supercritical condition (e.g., CO2) the high pressures are particularly demanding on windage resistance. Having the inside-out compressor operating as the first stage of compression reduces the windage losses, and further having the magnetic stator on the high-side pressure of the working fluid further reduces the windage losses. The particularly preferred embodiment has the magnetic components operable as both the method to isolate the high-side pressure of the working fluid while concurrently being the magnetic stator (i.e., stator is an embedded electro-magnetic device). The preferred inside-out ramjet has windage losses of at least 10 percent lower than a standard (i.e., known in the art) centrifugal compressor or expander, specifically preferred of at least 30 percent lower than a centrifugal compressor or expander, or particularly preferred at least 70 percent lower than a centrifugal compressor or expander.

Another embodiment has the spool with outward facing surface grooves to increase the effective surface area for increased heat transfer removal. The additional heat dissipating components are radially connected to and in thermal communication with the spool. The surface grooves can be in the circumferential position of the spool, or in the radial position of the spool.

Yet another embodiment integrates a rotary ramjet compressor (inside-out configuration) with a concentric inside-out ramjet expander (i.e., having supersonic nozzle). In one preferred configuration the ramjet compressor has a smaller rotor diameter (in relationship to the shaft centerline) than the ramjet expander rotor diameter. The particularly preferred shaft has a concentric double-helix such that the shaft is concurrently the device to impart rotation on all of the rotating components and also as the electrical coil. The combination of the concentric double-helix embedded shaft coil is a significant increase in magnetic losses induced due to high temperatures (as known in the art of permanent magnets). The embedded electrical coil, as anticipated in this invention, can be any rotating surface, and is preferably an embedded concentric double-helix. The particularly preferred embedded concentric double-helix is self supporting and is a monolithic conductor that uniquely can sustain high centrifugal forces of greater than 3 times the force of gravity, or specifically greater than 10 times the force of gravity, particularly greater than 1000 times the force of gravity. The particularly specific embodiment can sustain high centrifugal forces of greater than 100,000 times gravity and even greater than 1 million times the force of gravity.

Another embodiment is an integrated compressor system that has a first inside-out ramjet compressor (i.e., with a supersonic diffuser) with a second compressor that is radially connected to the first inside-out ramjet compressor. The second compressor in one preferred embodiment is also an inside-out ramjet compressor. Another embodiment is the second compressor being a radial/centrifugal compressor. The invention anticipates the first compressor having a larger rotor diameter than the second compressor diameter. A preferred configuration is such that the stationary spacer of the inside-out ramjet contains within its interior space a stationary volute for the second compressor. Another preferred configuration is such that the first inside-out ramjet compressor working fluid inlet is axially in line with the second compressors discharge volute. It is further anticipated in the invention that the first inside-out ramjet working fluid inlet can also be axially in line with the second compressors discharge either on the same side or opposite sides.

Yet another embodiment of any of the inside-out ramjet configurations has the aforementioned embedded electrical coil being a double-helix coil having at least two poles. The preferred configuration has the electrical coil embedded within the shaft to further isolate the electrical coil from the high-side pressure working fluid, as the working fluid can have an operating temperature in excess of 1000 degrees Fahrenheit, or even in excess of 2000 degrees Fahrenheit. A particularly preferred double-helix has concentric layers such that each of the concentric layers can withstand temperatures in excess of 200 degrees Celsius, or specifically in excess of 350 degrees Celsius, or particularly in excess of 600 degrees Celsius. The electric coil can be configured to be radially outward of the at least one supersonic diffuser or supersonic nozzle. The electrical coil comprised of concentric layers with the monolithic conductors are preferably manufactured by a sequential process of etching (preferably chemical etching to create grooves within each layer) and electroplating (preferably selective plating, which can also include methods known in the art to both isolate two electrical surfaces from each other).

Another preferred embodiment is an external magnetic stator separated from the working fluid using an encasement to shield the external magnetic stator from at least one of the high-side or low-side pressure of the working fluid. The isolation of the external magnetic stator from the working fluid, and in particular the solvency of supercritical CO2 and/or high temperatures (in excess of 200 degrees Celsius or even 350 degrees Celsius) that would reduce the magnetic strength (i.e., electro-magnetic losses). Yet another preferred configuration is such that the embedded coil is embedded within any of the rotating components, and is radially in line with the external stator. Such a monolithic coil can take on virtually any shape such that as many components become multifunctional as possible. The combination of the internal magnetic stator and the embedded coil are now operable as an axial motor or axial generator. A portion of the embedded coil can be preferably partitioned from the remained (the bulk) of the embedded coil such that the embedded coil within the spool is also operable as a magnetic bearing (and individually controlled). The aforementioned axial motor is applicable and anticipated for virtually any type of compressor (or even pump) as known in the art such that this configuration enables both working fluid isolation, greatly diminished impact of high temperature, and further reduction of physical size/weight.

It is understood that virtually all representations of the inside-out ramjet as a compressor can be substituted as an expander.

It is understood in this invention that a combination of scenarios can be assembled through the use of compression devices, expansion devices, heat exchangers, and fluid valves such that any of the alternate configurations can be in parallel enabling the invention to support a wide range of power generation and compression processes. These include the ramjet is operable as at least one of an air compressor, natural gas compressor, turbocharger compressor component, turbocharger expander component, air conditioning compressor, power generation expander, or a power generation compressor. The ramjet is also operable as a fractionation device to separate out individual components within the working fluid by utilizing the centrifugal forces of greater than 10,000 times gravity.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A rotary ramjet having a supersonic diffuser operable to reduce compression energy consumption to compress a compressible fluid comprising a first inside-out compressor having a rotor subjected to compressive loads, and a spool operable as a containment rim for the rotor radially connected to a shaft.

2. The ramjet according to claim 1 further comprised of a second compressor with an outside-in configuration having a compressor stator whereby the first inside-out compressor and the second outside-in compressor have the same compressor stator whereby the outward facing side of the compressor stator is for the first inside-out compressor and the inward facing side of the compressor stator is for the second outside-in compressor.

3. The ramjet according to claim 1 further comprised of an electrical coil whereby the electrical coil is embedded within the spool operable to impart compressive force to counteract the Lorentz forces acting on the electrical coil.

4. The ramjet according to claim 1 further comprised of an electrical coil, a magnetic stator, a spacer, whereby the first inside-out compressor has a low-side pressure and a high-side pressure of the working fluid whereby the electrical coil is embedded within the spacer operable to impart compressive force to counteract the Lorentz forces acting on the electrical coil and to isolate the electrical coil and the magnetic stator from the high-side compressible fluid.

5. The ramjet according to claim 1 whereby the compressor stator is comprised of magnetic components operable to both isolate the high-side pressure of the working fluid and concurrently be the magnetic stator.

6. The ramjet according to claim 1 whereby the spool has outward facing surface grooves operable to increase surface area and to increase heat transfer removal from the spool and further components radially connected and in thermal communication with the spool.

7. A rotary ramjet operable to reduce compression energy consumption to compress a compressible fluid comprising an inside-out compressor having a supersonic diffuser and having a compressor rotor subjected to compressive loads, a compressor spool operable as a containment rim for the compressor rotor; and an inside out expander having a supersonic nozzle and having an expander rotor subjected to compressive loads, an expander spool operable as a containment rim for the expander rotor whereby the compressor is radially connected to the expander, whereby the expander rotor is radially connected to the compressor rotor and a shaft, and whereby the compressor has a smaller compressor rotor diameter than the expander rotor diameter.

8. The rotary ramjet according to claim 7 whereby the shaft is comprised of a concentric double-helix operable as an electrical coil.

9. The rotary ramjet according to claim 7 whereby the expander rotor has embedded concentric double-helix operable as an electrical coil.

10. The rotary ramjet according to claim 8 whereby the embedded concentric double-helix is self supporting and is a monolithic conductor operable to sustain high centrifugal forces of greater than 10 times gravity.

11. The rotary ramjet according to claim 8 whereby the embedded concentric double-helix is self supporting and is a monolithic conductor operable to sustain high centrifugal forces of greater than 1000 times gravity.

12. The rotary ramjet according to claim 8 whereby the embedded concentric double-helix is self supporting and is a monolithic conductor operable to sustain high centrifugal forces of greater than 100,000 times gravity.

13. The rotary ramjet according to claim 9 whereby the embedded concentric double-helix is self supporting and is a monolithic conductor operable to sustain high centrifugal forces of greater than 10 times gravity.

14. The rotary ramjet according to claim 9 whereby the embedded concentric double-helix is self supporting and is a monolithic conductor operable to sustain high centrifugal forces of greater than 1000 times gravity.

15. The rotary ramjet according to claim 9 whereby the embedded concentric double-helix is self supporting and is a monolithic conductor operable to sustain high centrifugal forces of greater than 100,000 times gravity.

16. A rotary ramjet operable to reduce compression energy consumption to compress a compressible fluid comprising a first compressor having a supersonic diffuser and having a first compressor rotor subjected to compressive loads, a compressor spool operable as a containment rim for the compressor rotor; and a second compressor whereby the first compressor is radially connected to the second compressor, whereby the first compressor is radially connected to the first compressor rotor, to the second compressor and to a shaft whereby the first compressor has a larger first compressor rotor diameter than the second compressor diameter.

17. The rotary ramjet according to claim 16 whereby the first compressor is an inside-out compressor.

18. The rotary ramjet according to claim 16 whereby the second compressor is an inside-out compressor.

19. The rotary ramjet according to claim 16 whereby the second compressor is an outside-in compressor.

20. The rotary ramjet according to claim 16 whereby the second compressor is a centrifugal compressor.

21. The rotary ramjet according to claim 16 further comprised of a stationary spacer and a stationary volute for the second compressor whereby the volute is contained within the spacer.

22. The rotary ramjet according to claim 16 having a first compressor inlet and a second compressor discharge, whereby the first compressor inlet is axially in line with the second compressor discharge.

23. A ramjet comprised of a working fluid, a high-side and low-side pressure of the working fluid, a shaft, at least one of supersonic diffuser or supersonic nozzle contained within a spool and radially connected to the shaft by the spool, an electrical coil having double-helix coil, whereby the electrical coil is isolated from the high-side pressure working fluid, and wherein the double-helix coil is comprised of monolithic conductor operable to sustain high centrifugal forces.

24. The ramjet according to claim 23, wherein the double-helix coil is comprised of at least two poles and whereby the electrical coil is embedded within the shaft operable to isolate the electrical coil from both the high-side pressure working fluid having an operating temperature in excess of 1000 degrees Fahrenheit.

25. The ramjet according to claim 24 further comprised of at least one of a spacer, a discharge volute, and a stationary outward facing interior space within the spool; a magnetic stator wherein the magnetic stator is contained within the at least one spacer, discharge volute, and interior space within the spool operable to isolate the magnetic stator from the high-side pressure working fluid.

26. The ramjet according to claim 24 further comprised of at least one of a spacer, a discharge volute, and a stationary outward facing interior space within the spool; a magnetic stator wherein the magnetic stator is contained within the at least one spacer, discharge volute, and interior space within the spool operable to isolate the magnetic stator from the high-side pressure working fluid.

27. The ramjet according to claim 23, wherein the double-helix coil is comprised of at least two poles and whereby the electrical coil is embedded within the spool operable to impart compressive force to counteract the Lorentz forces acting on the electrical coil.

28. The ramjet according to claim 24, wherein the double-helix is comprised of concentric layers and whereby each of the concentric layers is operable to temperatures greater than 200 degrees Celsius.

29. The ramjet according to claim 24, wherein the double-helix is comprised of concentric layers and whereby each of the concentric layers is operable to temperatures greater than 350 degrees Celsius.

30. The ramjet according to claim 23, wherein the electric coil is radially outward of the at least one supersonic diffuser and supersonic nozzle.

31. The ramjet according to claim 23 wherein the working fluid is carbon dioxide having a high-side pressure of greater than the supercritical pressure.
